(19) United States
(12) Patent Application Publication
(10) Pub. No.: US 2007/0276849 A1
(43) Pub. Date: Nov. 29, 2007

(54) Transferring Data Between Devices

(75) Inventors: Mika Konno, Turku (FI); Marja Helle, Turku (FI); Arto Vuorinen, Piikkio (FI); Jussi Hamalainen, Salo (FI); Petteri Vairio, Kaarina (FI); Kari Kunnas, Rekijoki (FI); Valtteri Eroma, Helsinki (FI); Waldemar Sakalus, Ratingen (DE); Raphael Grignani, Helsinki (FI)

Correspondence Address: FOLEY & LARDNER LLP, P.O. BOX 80278, SAN DIEGO, CA, 92138-0278, US

(73) Assignee: NOKIA CORPORATION, Espoo (FI)

(21) Appl. No.: 10/594,462

(22) PCT Filed: Jun. 29, 2004
(86) PCT No.: PCT/FI04/00403

§ 371 Date: Jul. 30, 2007

(30) Foreign Application Priority Data
Feb. 27, 2004 (FI) 20040319

(51) Int. Cl. G06F 17/00; G06F 13/00

(52) U.S. Cl. 707/101; 707/E17.005

(57) ABSTRACT

The present invention relates to a method for transferring a data file between a sending device and a receiving user equipment. The method comprises assessing, based on information relating to a transfer method and/or receiving user equipment, if the data file is to be modified. In response to finding that the data file is to be modified, the data file is modified, based on said information, into a form suitable for transferring. The data file is transferred from the sending device to the receiving user equipment. In an embodiment, the data file to be transferred is an image file and the sending device is a digital camera. The image file may be re-sized and further re-scaled for transferring.

### FIELD OF THE INVENTION

The present invention relates to communication systems and, in particular, to transferring data between a sending device and a receiving user equipment.

### BACKGROUND OF THE INVENTION

In a communication system, two or more entities, such as user equipment and/or other nodes associated with the communication system, may communicate with each other. Communication systems may be fixed, such as the public switched telephone network (PSTN), or mobile, such as the global system for mobile communication (GSM) or various GSM based systems, such as general packet radio service (GPRS), third generation standards, such as the universal mobile telecommunication system (UMTS) and other communication systems that are based on the wideband code division multiple access (WCDMA). A communication system may also be based on local area network (LAN) standards.

Subscribers, such as the users, to a communication system may be offered and provided numerous services, like two-way or multi-way calls, data communication or multimedia services. In addition to call functions, the communication systems may support, for example, short message service (SMS), multimedia message service (MMS) and wireless applications protocol (WAP). A user may access a network of a communication system by means of a user equipment, such as a personal computer (PC), personal digital assistant (PDA), mobile station (MS) and so on.

User equipment may communicate with further user equipment or other devices, such as camera or music player, compatible with the first user equipment. A compatible device may be connected to the user equipment using various connections including, but not limited to, galvanic connections, such as universal serial bus (USB) port, Pop-Port interface and so on, wireless connections, such as Bluetooth, infrared, wireless local area network (WLAN), and so on, optical connections and direct connector connections.

It may be desirable to be able to connect to user equipment also a device which is not designed to cooperate with the particular user equipment. For example, a digital camera may conveniently be used to create image files of still or moving images. A digital camera may have resolution capacity for example up to 3 megapixels (Mp). The image file obtained using such a 3 Mp digital camera may vary from about 60 kB to several megabytes depending on the settings of the camera. Often, users tend to take high resolution images, i.e. images of several megabytes. Typically, the image files may be transferred to a PC or another such relatively high capacity receiving user equipment. Such relatively high capacity receiving user equipment need not necessarily be designed compatible with the digital camera.

However, it might be desirable also to be able to transfer files, such as image files, from a sending device, such as a digital camera, to more limited capacity receiving user equipment, in particular to mobile user equipment, such as a MS or a PDA, an image viewer, and so on. This may be possible, but typically requires manual intervention of the user, which may be quite complicated. The user of the sending device may need to know the type of the receiving user equipment and possible limitations relating to the receiving user equipment or, respectively, the type and possible limitations relating to a transfer method to be used. The user may need to manually modify the file in order to adapt the file in the requirements set by the transfer method and/or the receiving user equipment.

There is, therefore, a need for an improved method for transferring files between devices.

### SUMMARY OF THE INVENTION

Embodiments of the present invention aim to address one or several of the above problems or issues.

According to an aspect of the present invention, there is provided a method for transferring a data file between a sending device and a receiving user equipment. The method comprises assessing, based on information relating to a transfer method and/or receiving user equipment, if the data file is to be modified. Furthermore, the method comprises, in response to finding that the data file is to be modified, modifying the data file, based on said information, into a form suitable for transferring. Furthermore, the method comprises transferring the data file from the sending device to the receiving user equipment.

According to a further aspect of the present invention, there is provided a computer program comprising program code means for performing any of the steps according to the invention when the program is run on a computing means.

According to a further aspect of the present invention, there is provided a device configured to communicate with a receiving user equipment for transferring a data file from the device to the receiving user equipment. The device is further configured to assess, based on information relating to a transfer method and/or receiving user equipment, if the data file is to be modified. Furthermore, the device is configured to modify, in response to finding that the data file is to be modified, the data file, based on said information, into a form suitable for transferring. The device is also configured to transfer the data file to the receiving user equipment. According to a further aspect of the present invention, there is provided user equipment configured to provide a separate device with an indication relating to a transfer method usable between the user equipment and the separate device or to the user equipment.

According to a further aspect of the present invention, there is provided an arrangement configured to transfer a data file between a sending device and a receiving user equipment. The arrangement is further configured to assess, based on information relating to a transfer method and/or receiving user equipment, if the data file is to be modified. Furthermore, the arrangement is configured to modify, in response to finding that the data file is to be modified, the data file, based on said information, into a form suitable for transferring.

In an embodiment, the data file to be transferred may be selected from a plurality of data files.

Preferably, the assessing is carried out by the sending device. In an embodiment the step of modifying may further comprise creating a clone data file of the original data file and modifying the clone data file.

In an embodiment, the step of modifying may comprise modifying the data file based on capacity limitations of the transfer method. The data file may be modified based on a maximum file size supported by the transfer method.

In an embodiment, the step of modifying may comprise modifying the data file based on capacity limitations of the receiving user equipment. The data file may be modified based on a maximum file size supported by the receiving user equipment.

The step of modifying may comprise compressing the data file. In an embodiment, the modifying step may comprise changing the format of the data file. For example, the data file may be modified from JPEG to GIF image format, based on information relating to the transfer method or the receiving device.

In an embodiment, the data file to be transferred is an image file. The step of modifying may then comprise re-sizing the image file. The step of modifying may further comprise re-scaling the re-sized image file.

In an embodiment, the data file to be transferred is an image file. The step of modifying may then comprise the changing of the data file format to JPEG from a non-JPEG format and to additionally re-size the image if the image size is not suitable for subsequent sending of a message, such as an MMS message, by the receiving user equipment.

In an embodiment, the sending device may obtain an indication relating to the transfer method. In an embodiment, the indication may be obtained by determining by the sending device an active transfer method capable of transferring the data file to the receiving user equipment. In an embodiment, the indication may be obtained receiving in the sending device the indication sent by the receiving user equipment. In an embodiment, the indication may be obtained by displaying to a user of the sending device a list of transfer methods and allowing the user to select an indication belonging to the list.

In an embodiment, the sending device may obtain an indication relating to the receiving user equipment. In an embodiment, the indication may be obtained by receiving in the sending device the indication sent by the receiving user equipment. In an embodiment, the indication may be obtained by displaying to a user of the sending device a list of receiving user equipment and allowing the user to select an indication belonging to the list.

The receiving user equipment may comprise one of a mobile user equipment, a mobile station and a personal digital assistant.

The sending device may comprise a digital camera.

The transfer method may be selected from a group comprising: universal serial bus port connection, Pop-Port connection, other galvanic connection, Bluetooth connection, infrared connection, wireless local area network connection, other wireless connection, direct connector connection or optical connection.

### BRIEF DESCRIPTION OF FIGURES

The invention will now be described in further detail, by way of example only, with reference to the following examples and accompanying drawings, in which:

FIG. 1 shows an example of an arrangement in which the embodiments of the invention may be implemented; and

FIG. 2 shows a flowchart of an embodiment of the invention.

### DETAILED DESCRIPTION OF THE PREFERRED EMBODIMENTS

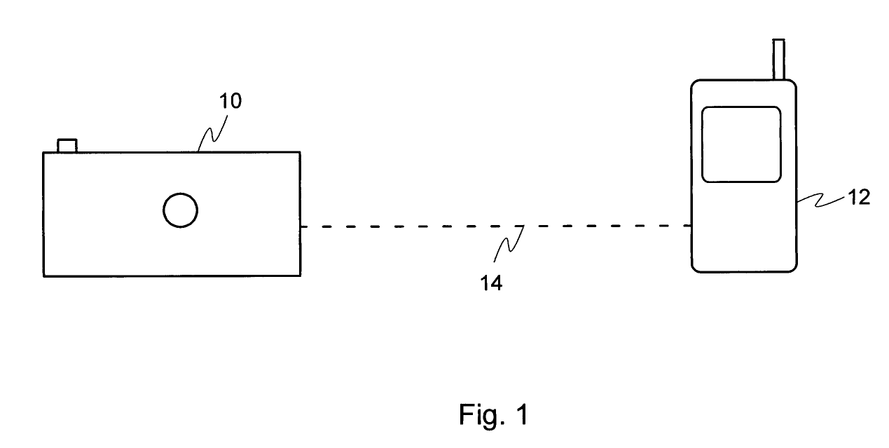

FIG. 1 shows an example of an arrangement of a digital camera as a sending device 10 and a mobile station as a receiving user equipment 12. The sending device 10 and the receiving user equipment 12 communicate with each other using a transfer method 14, such as a local transfer method for example over an air interface using a wireless technology, such as the Bluetooth. The transfer method 14 may be any appropriate local scale transfer method, for example a wireless link, a galvanic connection or a direct connector connection, some examples of which were given above.

It shall be appreciated that the digital camera and the mobile station are used as said sending and receiving devices for illustrative purposes in a way of example only. These devices may as well be any other appropriate devices between which a file is to be transferred. These devices need not to be designed compatible with each other. The devices are operable by themselves, i.e. the devices are stand-alone devices. Embodiments of the invention are described herein mainly referring to transfer of image files, but the files may also be other appropriate files, such as music files or multimedia files.

Before transferring a file to a receiving user equipment 12 not designed compatible with the sending device 10, characteristics, such as certain limitations, of the transfer method and/or the receiving user equipment need to be known. The transfer method and/or the receiving user equipment may have limitation for example relating to the file size. The storing capacity of the receiving user equipment may be lower than the file to be transferred requires. In some receiving user equipment, a further action, such as sending a message, e.g. MMS message, further, may be limited to a certain file size, for example about 32 kB. The original image file may be several times bigger, for example about 1.2 MB.

To be able to transfer the file from the sending device, such as a digital camera, to the receiving user equipment, such as a mobile station, the sending device needs to re-size the files to fit to the limitation. To obtain again an acceptable image from the transferred file, re-scaling may be needed. For example, when the original image file of 1.2 MB is re-sized to an image file of 32 kB, an important part of details and color information may be lost. After re-scaling, the image may be viewed almost as the original, but in small dimensions. Other appropriate data compressing methods may also be used.

In an embodiment, the format of the data file may be changed dependent of information received from the receiving user equipment. For example, when a further action takes place in the receiving user equipment, such as the example above of sending an MMS message, the preferred file format is an image file formatted according to the JPEG standard whereas the original data file may be formatted according to an uncompressed, unprocessed RAW image format Therefore, in response to receiving the information from the receiving user equipment, such as a mobile station, the sending device, such as a digital camera, may reformat the RAW image file into a JPEG image file, and possibly re-sizing the file, before transferring the file to the receiving user equipment.

In another example, the original data file may be a JPEG image file and the receiving user equipment may include a contacts database which supports only GIF image files. The sending device may assess based on information received from the receiving user equipment that conversion of the JPEG image file into the GIF format is required. The sending device will then perform the conversion prior to transferring the file to the receiving user equipment. The GIF image file transferred to the receiving user equipment may then be added to a record in the contacts database.

It has now been found that a procedure may be implemented to improve the communication between the receiving user equipment and the sending device. Thereby, file transfer may be improved and partially or entirely automated.

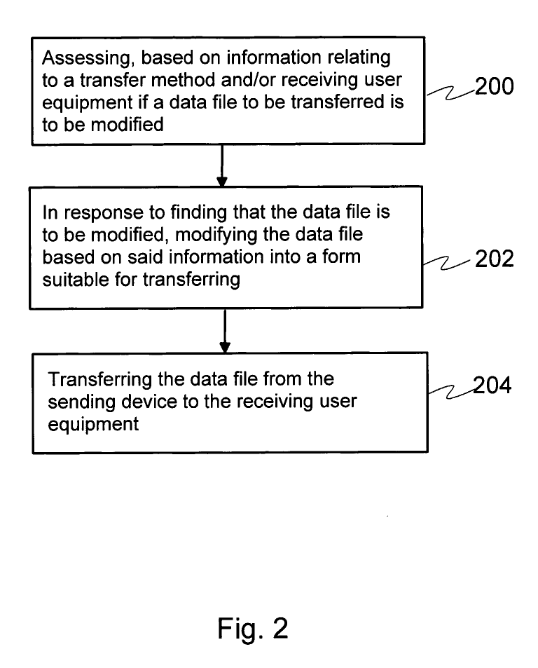

FIG. 2 shows a flow chart illustrating an embodiment of the invention for transferring a data file between a sending device and a receiving user equipment. The data may be selected from a plurality of data files. In step 200, it is assessed, based on information relating to a transfer method and/or receiving user equipment, if the data file is to be modified. Preferably, the assessing step is carried out in the sending device. In response to finding that the data file needs to be modified, the data file is modified, in step 202, based on said information, into a form suitable for transferring. In a preferred embodiment, in the modifying step, a clone data file is created of the original data file and the clone file is modified. In step 204, the data file is transferred from the sending device to the receiving user equipment.

In an embodiment, the transfer method and/or the receiving device may have lower capacity in respect of the file size than the file size of the data to be transferred. Modifying the data may thus comprise reducing the file size of the data to be transferred. Some embodiments are explained in the following description. Other appropriate ways may also be used.

Various steps of the embodiments may require a computer program comprising program code means to be introduced in the receiving device and, in some embodiments, also in the sending device.

Furthermore, devices configured to work in accordance with the embodiments of the invention are provided. In some embodiments, no modifications are needed in the sending device, but the receiving device, i.e. the receiving user equipment, provides all the required information and functionality. In some embodiments, the functionalities may be shared between the sending and receiving devices in an appropriate manner. These alternatives shall become apparent from the following description.

In a sending device 10, such as a digital camera, a device menu, also called gallery, typically provides a possibility to select desired images, some editing features, and so on. In embodiments of the invention, the device menu may be provided with a feature for selecting files and indicating the sending device that the selected files are to be transferred to a receiving user equipment 12. The selecting and indicating function of the device menu may further comprise a possibility to select and/or indicate a transfer method to be used, such as galvanic connection, e.g. Pop-Port, USB, or wireless connection, e.g. Bluetooth, infrared or WLAN, optical connection, direct connector connection, and so on. The sending device 10 may then automatically start a file transfer procedure for transferring the file(s) to the receiving user equipment 12.

In an embodiment, the user may be given a possibility to initiate the file transfer procedure and optionally also to make choices during the file transfer procedure. For example, at least one option may be displayed to the user, such as an accept option or a cancel option or another appropriate option, to be selected by the user for example by pressing an appropriate key or highlighting the selected option. Such various selection techniques are well known to a skilled person and are not further discussed herein.

A communication session between the sending device 10 and the receiving user equipment 12 may be initiated by one or other of the two. In an embodiment, the sending device queries, preferably automatically, information required for preparing the file transfer. The sending device may determine a type of a transfer method which is active or becomes active between the sending device 10 and the receiving user equipment 12. The sending device 10 may then become aware of the possible limitations or other conditions relating to the transfer method. The awareness may be created by a protocol present in the sending device. In an embodiment, the sending device may be provided with an access to an information site of the receiving user equipment, such as the messaging application programming interface (API) of a mobile station, providing information of possible limitations relating to the transfer method and/or the receiving user equipment.

In an embodiment, the receiving user equipment 12 initiates a communication session between the receiving user equipment 12 and the sending device 10. The receiving user equipment may provide the sending device with information of the transfer method to be used, such as galvanic connection, e.g. Pop-Port, USB, or wireless connection, e.g. infrared, Bluetooth or WLAN, optical connection or direct connector connection. Information of the characteristics relating to the receiving user equipment and/or said transfer method, such as file size limitation, resolution and the like, may also be provided. For example, the receiving user equipment may send an information file comprising all the required information. In an alternative, simply an indication of the transfer method and/or the type of the receiving user equipment may be provided.

In some embodiments, for example when the sending device 10 determines itself the active transfer method or if the receiving user equipment 12 sends the sending device an indication as explained above, the sending device may be provided with a list of different possible transfer methods and/or receiving user equipment. The list may provide the details for modifying the file, or the clone file, to fit to the limitations set by the transfer method and/or the receiving user equipment. The list may, for example, be provided as a piece of software, by the manufacturer or by a user, or in another appropriate manner.

Limitations may be set by the transfer method used between the sending device 10 and the receiving user equipment 12. Also the receiving user equipment 12 may set limitations. Limitations may relate to capacity of the transfer method or the receiving user equipment and may indicate, for example, the maximum file size supported by said transfer method or said receiving user equipment. Furthermore, in an embodiment, the receiving user equipment 12 may provide the sending device 10 tools, such as a piece of software, to assess whether the file needs to be modified. In an alternative, the sending device is provided with the assessing information for example as a piece of software, by the manufacturer or by a user prior to initiate the file transfer.

In an alternative, the user may give the sending device 10 information relating to the receiving user equipment 12. For example, a list may be displayed to a user for selecting different transfer methods and different types of possible receiving user equipment.

The required information to be provided to the sending device 10 may depend on the receiving user equipment 12 and/or the transfer method 14. In the case of image file transfer, the required information may be the resolution and the file size supported by the transfer method and the receiving user equipment. For example, a Pop-Port interface may only allow transferring a maximum file size of 60 kB. The receiving user equipment may set a limit, for example, such that the file may be modified or transferred further in an efficient way. In an implementation, receiving user equipment may support sending a message, such as an MMS message, of a maximum size. For example, an image file having video graphics array (VGA) resolution of 640×480 pixels and maximum size of 32 kB may be supported, irrespective of the original image resolution and file size. As another example, a Bluetooth connection, to other devices than a PC and a printer, may only allow transferring an image file having VGA resolution of 640×480 pixels and maximum size of 100 kB. In the case of other type of file transfer, such as a music file, for example file size may be limited.

The sending device 10 assesses, based on information relating to the transfer type and/or the receiving user equipment, whether the file to be transferred needs to be modified, such as re-sized and/or re-scaled. Preferably, assessing is carried out automatically.

If the sending device assesses that the file to be transferred needs or is instructed to be re-sized and/or re-scaled or otherwise modified, the sending device preferably creates a clone file of the original file. Creating a clone file leaves the original file intact and thereby the original file may remain in the sending device. When the file transfer is completed the clone file(s) may be deleted automatically or manually from the sending device for example to save the storing capacity of the sending device.

In an alternative, the original file may be modified directly instead of first creating a clone file. Such an embodiment may, however, not be advantageous, as the original file may be lost.

Based on the information relating to the receiving user equipment, the sending device modifies the file, preferably the clone file to make it suitable for the file transfer. The file may be re-sized and/or re-scaled as explained above. For example in an image file, the original aspect ratio can thus be preserved.

The file modification is preferably automatic. In an alternative, the user may be given a possibility to make choices as explained above.

After having made the file, preferably the clone file, suitable for the file transfer, the sending device 10 starts sending the file to the receiving user equipment 12 using the transfer method selected by the user, determined by the sending device, informed by the receiving user equipment or obtained in another way. The receiving user equipment 12 receives the file, or the clone file. The received file may be modified further in the receiving user equipment in an appropriate manner. For example, an image file may be re-sized and/or re-scaled back to its original size or to another desired size. The file may be sent further, for example using email or MMS.

Embodiments of the invention may simplify user interface and user experience of the sending device, such as a digital camera. User is required to know only few, or not at all, limitations relating to the receiving user equipment and transfer method. The success rate and the user-perceived success of an action like “sending a picture to another device” may become higher, leading to a better user experience and user self satisfaction of performing successfully said action. This method may also decrease even substantially the threshold of sending messages, such as MMS messages, using for example pictures taken with a digital camera, when the camera is not an accessory of the user equipment used for sending the message.

Although the invention has been described in the context of particular embodiments, various modifications are possible without departing from the scope and spirit of the invention as defined by the appended claims. For example, the communication system may be any appropriate communication system. The sending and receiving devices may be any appropriate devices and the transfer technology may be any appropriate transfer technology, not limiting to the examples mentioned in the foregoing description.

1. A method for transferring a data file between a sending device and a receiving user equipment, the method comprising:
assessing, based on information relating to a transfer method and/or receiving user equipment, if the data file is to be modified;
in response to finding that the data file is to be modified, modifying the data file, based on said information, into a form suitable for transferring; and
transferring the data file from the sending device to the receiving user equipment.

2. A method according to claim 1, further comprising selecting the data file to be transferred from a plurality of data files.

3. A method according to claim 1, wherein the step of assessing comprises carrying out said assessing by the sending device.

4. A method according to claim 1, wherein the step of modifying further comprises creating a clone data file of the original data file and modifying the clone data file.

5. A method according to claim 1, wherein the step of modifying comprises modifying the data file based on capacity limitations of the transfer method.

6. A method according to claim 5, wherein the step of modifying comprises modifying the data file based on a maximum file size supported by the transfer method.

7. A method according to claim 1, wherein the step of modifying comprises modifying the data file based on capacity limitations of the receiving user equipment.

8. A method according to claim 7, wherein the step of modifying comprises modifying the data file based on a maximum file size supported by the receiving user equipment.

9. A method according to claim 1, wherein the step of modifying comprises compressing the data file.

10. A method according to claim 1, wherein the step of transferring the data file comprises transferring an image file.

11. A method according to claim 10 wherein the step of modifying comprises resizing the image file.

12. A method according to claim 11 wherein the step of modifying further comprises re-scaling the re-sized image file.

13. A method according to claim 1, wherein the step of modifying comprises changing the format of the data file.

14. A method according to claim 1, further comprising obtaining in the sending device an indication relating to the transfer method.

15. A method according to claim 14, wherein the step of obtaining the indication relating to the transfer method comprises determining by the sending device an active transfer method capable of transferring the data file to the receiving user equipment.

16. A method according to claim 14, wherein the step of obtaining the indication relating to the transfer method comprises receiving in the sending device the indication sent by the receiving user equipment.

17. A method according to claim 14, wherein the step of obtaining the indication relating to the transfer method comprises displaying to a user of the sending device a list of transfer methods and allowing the user to select an indication belonging to the list.

18. A method according to claim 1, further comprising obtaining in the sending device an indication relating to the receiving user equipment.

19. A method according to claim 18, wherein the step of obtaining the indication relating to the receiving user equipment comprises receiving in the sending device the indication sent by the receiving user equipment.

20. A method according to claim 18, wherein the step of obtaining the indication relating to the receiving user equipment comprises displaying to a user of the sending device a list of receiving user equipment and allowing the user to select an indication belonging to the list.

21. A computer program comprising program code means for performing any of the steps according to any of claims 1-20 when the program is run on a computing means.

22. A device configured to:
communicate with a receiving user equipment for transferring a data file from the device to the receiving user equipment;
assess, based on information relating to a transfer method and/or receiving user equipment, if the data file is to be modified;
in response to finding that the data file is to be modified, modify the data file, based on said information, into a form suitable for transferring; and
transfer the data file to the receiving user equipment.

23. A device according to claim 22, wherein the device is configured to create a clone data file of the original data file to be used in the modification.

24. A device according to claim 22, wherein the device is configured to carry out the modification by compressing the data file.

25. A device according to any of claim 22, wherein the data file is an image file.

26. A device according to claim 25, wherein the device is configured to carry out the modification by re-sizing the image file.

27. A device according to claim 26, wherein the device is configured to carry out the modification by re-scaling the re-sized image file.

28. A device according to any of claim 22, wherein the device is configured to carry out the modification by changing the format of the data file.

29. A device according to any of claim 22, further configured to determine an active transfer method capable of transferring the information to the receiving user equipment.

30. A device according to any of claim 22, further configured to receive an indication of the transfer method and/or the receiving user equipment from the receiving user equipment.

31. A device according to any of claim 22, further configured to display to a user of the device a list of transfer methods and/or the receiving user equipment and to allow the user to select an indication belonging to the list.

32. A device comprising:
transferring means for transferring a data file from the device to a receiving user equipment;
assessing means for assessing, based on information relating to a transfer method and/or receiving user equipment, if the data file is to be modified before transferring;
modifying means for modifying, in response to finding that the data file is to be modified, the data file, based on said information, into a form suitable for transferring.

33. User equipment configured to provide a separate device with an indication relating to a transfer method usable between the user equipment and the separate device and/or with an indication relating to the user equipment.

34. An arrangement configured to transfer a data file from a sending device and a receiving user equipment, the arrangement being further configured to:
assess, based on information relating to a transfer method and/or receiving user equipment, if the data file is to be modified;
in response to finding that the data file is to be modified, modify the data file, based on said information, into a form suitable for transferring.

35. An arrangement according to claim 34, wherein the receiving user equipment comprises one of a mobile user equipment, a mobile station and a personal digital assistant.

36. An arrangement according to claim 34, wherein the sending device comprises a digital camera.

37. An arrangement according to any of claim 34, wherein the transfer method is selected from a group comprising: universal serial bus port connection. Pop-Port connection, other galvanic connection, Bluetooth connection, infrared connection, wireless local area network connection, other wireless connection, direct connector connection or optical connection.

38. An arrangement according to any of claim 34, wherein the sending device and the receiving user equipment are stand-alone devices.

39. A computer program product embodied on a computer-readable medium for transferring a data file between a sending device and a receiving user equipment, the computer program product comprising:
Computer code for:
assessing, based on information relating to a transfer method and/or receiving user equipment, if the data file is to be modified;
in response to finding that the data file is to be modified, modifying the data file, based on said information, into a form suitable for transferring; and
transferring the data file from the sending device to the receiving user equipment.

40. A computer program product according to claim 39, further comprising computer code for selecting the data file to be transferred from a plurality of data files.

41. A computer program product according to claim 39, wherein the computer code for assessing further comprises computer code for carrying out said assessing by the sending device.

42. A computer program product according to claim 39, wherein the computer code for modifying further comprises computer code for creating a clone data file of the original data file and modifying the clone data file.

43. A computer program product according to claim 39, wherein the computer code for modifying further comprises computer code for modifying the data file based on capacity limitations of the transfer method.

44. A computer program product according to claim 43, wherein the computer code for modifying further comprises computer code for modifying the data file based on a maximum file size supported by the transfer method.

45. A computer program product according to claim 39, wherein the computer code for modifying further comprises computer code for modifying the data file based on capacity limitations of the receiving user equipment.

46. A computer program product according to claim 45, wherein the computer code for modifying further comprises computer code for modifying the data file based on a maximum file size supported by the receiving user equipment.

47. A computer program product according to claim 39, wherein the computer code for modifying further comprises computer code for compressing the data file.

48. A computer program product according to claim 39, wherein the computer code for transferring the data file further comprises computer code for transferring an image file.

49. A computer program product according to claim 48, wherein the computer code for modifying further comprises computer code for resizing the image file.

50. A computer program product according to claim 49, wherein the computer code for modifying further comprises computer code for re-scaling the re-sized image file.

51. A computer program product according to claim 39, wherein the computer code for modifying further comprises computer code for changing the format of the data file.

52. A computer program product according to claim 39, further comprising computer code for obtaining in the sending device an indication relating to the transfer.

53. A computer program product according to claim 52, wherein the computer code for obtaining the indication relating to the transfer further comprises computer code for determining by the sending device an active transfer method capable of transferring the data file to the receiving user equipment.

54. A computer program product according to claim 52, wherein the computer code for obtaining the indication relating to the transfer further comprises computer code for receiving in the sending device the indication sent by the receiving user equipment.

55. A computer program product according to claim 52, wherein the computer code for obtaining the indication relating to the transfer further comprises computer code for displaying to a user of the sending device a list of transfer methods and allowing the user to select an indication belonging to the list.

56. A computer program product according to claim 39, further comprising computer code for obtaining in the sending device an indication relating to the receiving user equipment.

57. A computer program product according to claim 56, wherein the computer code for obtaining the indication relating to the receiving user equipment further comprises computer code for receiving in the sending device the indication sent by the receiving user equipment.

58. A computer program product according to claim 56, wherein the computer code for obtaining the indication relating to the receiving user equipment further comprises computer code for displaying to a user of the sending device a list of receiving user equipment and allowing the user to select an indication belonging to the list.
